(19) United States
(12) Patent Application Publication
(10) Pub. No.: US 2021/0123462 A1
(43) Pub. Date: Apr. 29, 2021

(54) HYDRAULIC ACTUATOR SYSTEM HAVING DYNAMIC LOAD SENSE BOOST VALVE

(71) Applicant: HydraForce, Inc., Lincolnshire, IL (US)

(72) Inventors: Damien Bonenfant, Lincolnshire, IL (US); Barry German, Buffalo Grove, IL (US); Travis Schmidt, Oregon City, OR (US); David Ruxton, Lakemoor, IL (US)

(73) Assignee: HydraForce, Inc., Lincolnshire, IL (US)

(21) Appl. No.: 17/081,839

(22) Filed: Oct. 27, 2020

Related U.S. Application Data
(60) Provisional application No. 62/926,557, filed on Oct. 27, 2019.

(51) Int. Cl. F15B 13/04

(52) U.S. Cl. CPC F15B 13/0418; F15B 2211/6054

(57) ABSTRACT

A hydraulic actuator system includes a load sense assembly that is configured to transmit a load sense signal to a variable pump to vary a flow of pressurized fluid from the variable pump in response to the load sense signal to generate a desired flow to the actuator. The load sense assembly includes a load sense boost valve (LSBV) configured to dynamically boost the load-sense signal according to the desired margin pressure and the flow demand from the system. When flow demands are low, margin pressure will be above the set threshold of the adjustable LSBV, and no boosting occurs. When flow demands are high and pressure in the load sense line drops to the set threshold, or minimum margin pressure, the LSBV begins boosting the load sense signal pressure dynamically. The boosted load sense signal signals the variable pump to stroke and displace more fluid to increase flow to the actuator.

### CROSS-REFERENCE TO RELATED APPLICATIONS

This patent application claims the benefit of priority to U.S. Provisional Patent Application No. 62/926,557, filed Oct. 27, 2019, and entitled, “Hydraulic Actuator System Having Dynamic Load Sense Boost Valve,” which is incorporated in its entirety herein by this reference.

### TECHNICAL FIELD

This patent disclosure relates generally to a hydraulic actuator system and, more particularly, to a hydraulic actuator system including a load sense arrangement configured to transmit a load sense signal to a variable pump to vary a flow of pressurized fluid from the pump in response to the load sense signal to provide a desired flow to the actuator.

### BACKGROUND

Vehicles, such as, telehandlers, backhoe loaders, wheel loaders, tractors, excavators, etc., can include one or more actuators configured to selectively manipulate an implement. Typically, such an actuator is a hydraulic actuator that is controlled via a hydraulic actuator system. The hydraulic actuator system can include a combination of valves used to control the movement (e.g., over a reciprocal linear extend/retract range of travel or a rotational clockwise/counterclockwise range of travel) of a hydraulic actuator of the vehicle.

Such vehicles are being equipped with systems and accessories that require higher and higher flow rates to be delivered by its variable displacement pump. These high flow rates cause pressure losses in the lines between the pump and the actuator. For example, in addition to auxiliary hydraulics, the variable displacement pump typically supplies flow for steering and braking functions of the vehicle. A priority valve is typically provided that diverts this flow to these functions. The remaining flow capacity is available for auxiliary hydraulics. Priority valves and long auxiliary hydraulic piping runs can both add to the pressure drop between the pump pressure and the pressure delivered to the auxiliary actuator, which erode the available margin for load-sensing systems to perform and meet flow demands. As a result, such systems do not deliver the full flow of the hydraulic pump to the actuator at times of peak demand.

The traditional solution to this issue has been to improve the margin by boosting the load-sensing signal at the auxiliary coupling using a pressure reducing valve. When applied appropriately, the pressure reducing valve acts in reverse to amplify the load sense signal delivered to the pump through the load sense line. This approach results in an additive pressure boost (LSin+Spring Value=LSout) to increase the pressure of the load sense signal, thereby communicating a higher flow demand to the pump. This approach is cost-effective in terms of implementation cost, but it can be expensive in terms of operational costs. Using this approach, the load sense signal is always boosted by a constant value (i.e., the value added by the pressure-reducing valve) regardless of the actual flow demand from the actuator. This “constant on” approach can, therefore, consume additional fuel and heat the hydraulic fluid unnecessarily.

There is a continued need in the art to provide additional solutions to enhance the use and control of hydraulic actuators over a range of flow demand conditions. For example, there is a continued need for techniques for operating a variable pump to vary a flow of pressurized fluid from the pump to provide a desired flow to an actuator.

It will be appreciated that this background description has been created by the inventor to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure, in one aspect, is directed to embodiments of a hydraulic actuator system. In embodiments, a hydraulic actuator system includes a load sense assembly configured to dynamically boost a load sense signal provided to a variable pump under certain operating conditions.

In embodiments, a hydraulic actuator system includes a variable pump in fluid communication with an actuator and a load sense assembly. The load sense assembly is configured to transmit a dynamically boosted load sense signal to the variable pump to vary a flow of pressurized fluid from the variable pump in response to the load sense signal to generate a desired flow to the actuator.

In one embodiment, a hydraulic actuator system includes a variable pump, an actuator, a supply line, and a load sense assembly. The variable pump is configured to selectively deliver a flow of fluid. The variable pump is configured to vary the flow of fluid based upon a pressure of a load sense signal received. The actuator is in fluid communication with the variable pump to receive the flow of fluid therefrom. The supply line is in fluid communication with the variable pump and the actuator to deliver the flow of fluid from the variable pump to the actuator. The load sense assembly is in fluid communication with the variable pump via the supply line. The load sense assembly is configured to transmit the load sense signal to the variable pump. The load sense assembly is configured to increase the pressure of the load sense signal to increase the flow of fluid from the variable pump while the flow of fluid in the supply line meets a hydraulic condition.

In another aspect, embodiments of a load sense boost valve are disclosed. In one embodiment, a load sense boost valve includes a body, a spool, and a biasing assembly.

The body defines an axial bore, a pump port, a load sense signal port, and a load port. Each of the pump port, the load sense signal port, and the load port is in fluid communication with the axial bore.

The spool is movably disposed within the axial bore over a range of travel between a boosting position and a load sense position. The pump port and the load sense signal port are in fluid communication with each other when the spool is in the boosting position, and the pump port and the load sense signal port are in fluid isolation from each other when the spool is in the load sense position. The load port is in fluid isolation from both the pump port and the load sense signal port over the range of travel of the spool.

The spool defines a through passage that is configured such that the pump port and the load sense signal port are in fluid communication with each other via the through passage when the spool is in the boosting position. The spool includes a first pressure surface in fluid communication with the pump port, a second pressure surface in fluid communication with the load sense signal port, and a third pressure surface in fluid communication with the load port. The third pressure surface faces in opposing relationship to the first and second pressure surfaces such that pressure acting against the third pressure surface urges the spool to move to the boosting position and pressure acting against the first and second pressure surfaces urges the spool to move to the load sense position.

The biasing assembly is disposed within the body. The biasing assembly is configured to urge the spool to the boosting position via an adjustable biasing force.

In still another aspect, embodiments of a method of controlling a hydraulic actuator are disclosed. In one embodiment, a method of controlling a hydraulic actuator includes transmitting a load sense signal to a variable pump. A flow of fluid is discharged from the variable pump through a supply line to an actuator. The flow of fluid is based upon a pressure of the load sense signal. The pressure of the load sense signal transmitted to the variable pump is dynamically increased to maintain a pressure drop across an orifice within a predetermined range, the orifice disposed within the supply line between the variable pump and the actuator.

Further and alternative aspects and features of the disclosed principles will be appreciated from the following detailed description and the accompanying drawings. As will be appreciated, the hydraulic actuator systems, load sense boost valves, and methods disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic view of an embodiment of a hydraulic circuit in accordance with principles of the present disclosure, the hydraulic circuit including a variable pump, an actuator, a load sense assembly, and a tank, the load sense assembly including an embodiment of a load sense boost valve (LSBV) constructed in accordance with principles of the present disclosure.

FIG. 2 is an elevation view, in section, of an embodiment of a load sense boost valve (LSBV) constructed in accordance with principles of the present disclosure, illustrating the LSBV in a boosting position.

FIG. 3 is an elevation view, in section, of the LSBV of FIG. 2, illustrating the LSBV in a load sense position.

It should be understood that the drawings are not necessarily to scale and that the disclosed embodiments are illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

Embodiments of a hydraulic actuator system constructed in accordance with principles of the present disclosure are adapted to control the operation of one or more actuators of a vehicle (e.g., telehandlers, backhoe loaders, wheel loaders, tractors, excavators). Embodiments of a hydraulic actuator system constructed in accordance with principles of the present disclosure can include a load sense assembly configured to dynamically boost a load sense signal provided to a variable pump to help maintain a desired flow condition at an actuator.

The load sense assembly can be configured to monitor pressure losses in a supply line from a variable pump to an actuator and to increase the pressure in a load sense line directing a load sense signal to the above so that the load sense signal is above a true load pressure in order to maintain a desired pressure drop across the orifice. In embodiments, the load sense assembly is configured to provide a boosted load sense signal above the actual pressure present downstream of the orifice when the flow between the pump and the placement of the load sense assembly is high enough to create a pressure drop that is higher than desired.

In embodiments, a load sense assembly constructed according to principles of the present disclosure includes a load sense boost valve and an orifice. The load sense assembly can be configured to dynamically boost a load sense signal sent to a variable pump to maintain a pressure drop across the orifice within a predetermined range to thereby deliver a flow of hydraulic fluid to the actuator that is within a desired range.

In embodiments, a hydraulic actuator system includes a variable pump, an actuator, a supply line, and a load sense assembly. The variable pump is configured to selectively deliver a flow of fluid. The variable pump is configured to vary the flow of fluid based upon a pressure of a load sense signal received. The actuator is in fluid communication with the variable pump to receive the flow of fluid therefrom. The supply line is in fluid communication with the variable pump and the actuator to deliver the flow of fluid from the variable pump to the actuator. The load sense assembly is in fluid communication with the variable pump via the supply line. The load sense assembly is configured to transmit the load sense signal to the variable pump. The load sense assembly is configured to increase the pressure of the load sense signal to increase the flow of fluid from the variable pump while the flow of fluid in the supply line meets a hydraulic condition

Embodiments of a hydraulic actuator system constructed in accordance with principles of the present disclosure can help provide adequate flow to an actuator, even under high flow conditions. In addition, embodiments of a hydraulic actuator system constructed in accordance with principles of the present disclosure can include a load sense assembly with dynamic load sense signal boosting functionality that is operational without the use of complex software or electrical control units.

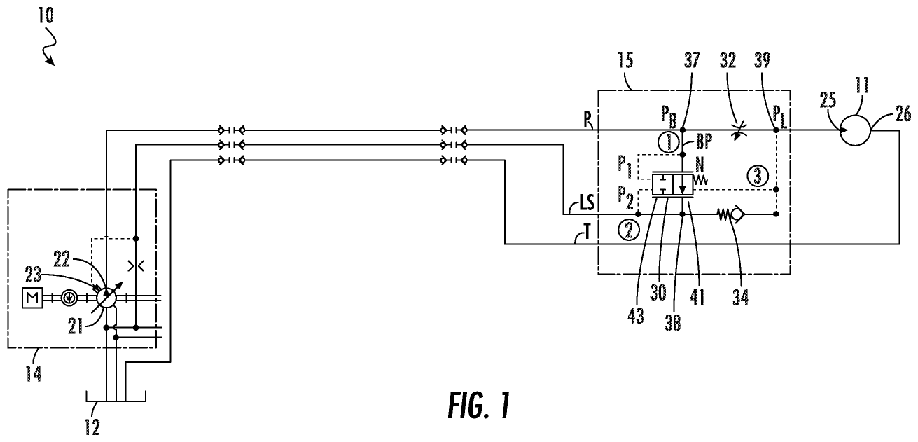

Turning now to the Figures, an embodiment of a hydraulic actuator system 10 constructed according to principles of the present disclosure is shown in FIG. 1. In the illustrated embodiment, the hydraulic actuator system 10 is adapted to selectively operate a hydraulic actuator 11 over a range of flow conditions. The illustrated hydraulic system 10 includes a tank 12, a variable pump 14, the actuator 11, and a load sense assembly 15.

It will be understood that, in other embodiments, the hydraulic actuator system 10 can be configured to selectively and independently operate a plurality of hydraulic actuators. For example, in embodiments, a suitable directional control valve system can be provided that is adapted to operate a subset or all of the actuators with which it is associated simultaneously.

In embodiments, the actuator 11 can be any suitable actuator. For example, in embodiments, the actuator 11 can comprise a cylinder, a rotary cylinder, a hydraulic motor, or other suitable actuator.

The tank 12 is adapted to hold a reservoir of hydraulic fluid. In embodiments, the tank 12 can be any suitable tank that is acceptable for the intended application, as will be readily understood by one skilled in the art. Further, those of skill in the art will appreciate that in embodiments the tank 12 can comprise a single tank or a plurality of tanks as the case may be. The tank 12 is in fluid communication with the variable pump 14, the actuator 11, and the load sense assembly 15 in an open hydraulic circuit arrangement. In embodiments, the tank 12 comprises a reservoir of hydraulic fluid which can be drawn into the pump 14 in order to generate a flow of hydraulic fluid for the system 10.

The pump 14 is in fluid communication with the tank 12 and the actuator 11. The pump 14 is adapted to receive a supply of fluid from the tank 12 and to discharge a supply flow of fluid to the actuator 11.

In embodiments, the pump 14 can be any suitable pump that is acceptable for the intended application, as will be readily understood by one skilled in the art. For example, in embodiments, the variable pump 14 comprises any suitable variable displacement pump (e.g., an axial-piston design). The pump 14 includes an inlet port 21, an outlet port 22, and a load sense signal port 23. The inlet port 21 of the pump 14 is in fluid communication with the tank 12. The outlet port 22 of the pump 14 is in fluid communication with the actuator 11 and the load sense assembly 15. The load sense signal port 23 of the pump 14 is in fluid communication with the load sense assembly 15. The pump 14 is adapted to draw the supply of hydraulic fluid from the tank 12 through the inlet port 21 and to discharge a supply flow of hydraulic fluid from the outlet port 22 to the actuator 11 via a supply line P. The supply line P is in fluid communication with the variable pump 14 and the actuator 11 to deliver the flow of hydraulic fluid from the variable pump 14 to the actuator 11.

In embodiments, the variable pump 14 is equipped with a load sensing controller adapted to vary the flow of the supply flow discharged from the outlet port 22 of the pump 14 based upon the pressure of the load sense signal received by the load sense signal port 23 of the pump 14 via a load sense line LS. In embodiments, the load sensing controller of the pump 14 is configured to react to increases in the load sense signal by increasing pump displacement to increase the pressure of the supply flow of hydraulic fluid delivered by the outlet port 22 of the pump 14 to the actuator 11. In embodiments, the pump 14 can be equipped with a pressure limiting controller (e.g., a pressure compensator) configured to limit the maximum operating pressure of the pump 14 by reducing pump displacement to zero when the maximum operating pressure is reached. In embodiments, the variable pump 14 can have other features and functionality, as will be appreciated by one skilled in the art.

In embodiments, the actuator 11 is adapted to use hydraulic power to perform a mechanical work operation. An actuator inlet port 25 of the actuator 11 is in fluid communication with the outlet port 22 of the pump 14 to receive the supply flow therefrom via the supply line P. An actuator outlet port 26 of the actuator 11 is in fluid communication with the tank 12 via a tank line T to discharge a discharge flow of hydraulic fluid thereto. The flow of hydraulic fluid through the actuator 11 can cause the actuator 11 to operate.

The load sense assembly 15 is configured to transmit a dynamically boosted load sense signal to the variable pump 14 to vary a flow of pressurized fluid from the variable pump 14 in response to the load sense signal to generate a desired flow to the actuator 11. The load sense assembly 15 is in fluid communication with the outlet port 22 of the pump 14 via the supply line P, the load sense line LS, and a load sense bypass line BP. The load sense assembly 15 is also in fluid communication with the load sense signal port 23 of the pump 14 via the load sense line LS.

The load sense assembly 15 is adapted to dynamically boost the load sense signal delivered through the load sense line LS to the load sense signal port 23 of the pump 14 according to the desired margin pressure and the flow demand of the system 10. The load sense assembly 15 is adapted to generate a boosted load sense signal to provide more flow to the actuator 11 in times of high demand, and, when demand is low, the load sense assembly 15 is adapted to generate a non-boosted load sense signal, thereby saving energy.

The illustrated load sense assembly 15 includes a load sense boost valve (LSBV) 30 constructed according to principles of the present disclosure, an orifice 32, a check valve 34, the load sense line LS, and the load sense bypass line BP. The LSBV 30 is in fluid communication with the outlet port 22 of the pump 14 via the supply line P and the load sense bypass line BP. The LSBV 30 is in fluid communication with the load sense signal port 23 of the pump 14 via the load sense line LS. The orifice 32 is in fluid communication with the outlet port 22 of the pump 14 via the supply line P such that the orifice 32 is interposed between the pump 14 and the actuator 11. The check valve is positioned on the load sense line LS.

The load sense bypass line BP branches from the supply line P at a first bypass junction 37 and is in fluid communication with the load sense line LS via a second bypass junction 38. The load sense line LS branches from the supply line P at a load sense junction 39 located downstream of the orifice 32.

The orifice 32 is found on the supply line P such that the orifice 32 is interposed between the first bypass junction 37 and the load sense junction 39 (i.e., downstream of the first bypass junction 37 and upstream of the load sense junction 39). In embodiments, the orifice 32 can be any suitable orifice for providing a non-boosted load sense signal, as will be appreciated by one skilled in the art. In embodiments, the orifice can comprise a directional control valve with proportional flow characteristics, a needle valve, or a fixed orifice, for example.

In embodiments, the LSBV 30 is configured to movable over a range of travel between a boosting position 41 and a load sense position 43 to selectively open and close the bypass line, respectively, to help maintain adequate flow through the actuator 11. When the LSBV 30 is in the load sense position 43, flow of hydraulic fluid through the bypass line BP is prevented, and a non-boosted load sense signal is provided to the load sense signal port 23 of the pump 14 with a pressure correlating to the downstream load pressure (P_{L}) of hydraulic fluid fed into the load sense line LS from the load sense junction of the supply line P downstream of the orifice. When the LSBV 30 is in the boosting position 41, a bypass flow of hydraulic fluid flows through the bypass line BP from the first bypass junction upstream of the orifice through the LSBV 30 to the second bypass junction, and a boosted load sense signal is provided to the load sense signal port 23 of the pump 14 with a boosted pressure (P_{B}) greater than a load pressure (P_{L}) of hydraulic fluid in the supply line P downstream of the orifice 32.

In embodiments, the load sense assembly 15 can include any suitable one-way flow device configured to prevent fluid flow from the bypass line BP from flowing in the load sense line LS from the second bypass junction 38 to the load sense junction 39. In the illustrated embodiment, the load sense assembly 15 includes the check valve 34.

The check valve 34 is fitted on the load sense line LS between the load sense junction 39 of the supply line P and the second bypass junction 38 of the load sense line LS such that the check valve 34 permits the flow of hydraulic fluid from the load sense junction 39 to the second bypass junction 38 and prevents flow in the reverse direction. When the LSBV 30 is in the boosting position 41, the check valve 34 prevents the bypass flow from the bypass line BP from flowing in the load sense line LS from the second bypass junction 38 to the load sense junction 39. The load sense line LS thus is configured to provide a load sense signal with a boosted pressure (P_{B}) that is greater than the load pressure (P_{L}) when the LSBV 30 is in the boosting position 41.

In embodiments, the load sense assembly 15 is in fluid communication with the variable pump 14 via the supply line P. The load sense assembly 15 can be configured to transmit the load sense signal to the variable pump 14. The load sense assembly 15 can be configured to increase the pressure of the load sense signal to increase the flow of fluid from the variable pump 14 while the flow of fluid in the supply line P meets a hydraulic condition.

In embodiments, the LSBV 30 is disposed within the bypass line BP, and the LSBV 30 is movable over a range of travel between the boosting position 41 and the load sense position 43. The bypass line BP is open when the LSBV 30 is in the boosting position 41 to permit fluid flow from the first bypass junction 37 through the LSBV 30 to the second bypass junction 38. The bypass line BP is occluded when the LSBV 30 is in the load sense position 43. The LSBV 30 is in the boosting position 41 when the hydraulic condition exists. In embodiments, the hydraulic condition comprises a pressure drop across the orifice 32 being outside of a predetermined range such that the LSBV 30 is in the load sense position 43 when the pressure drop across the orifice 32 is within the predetermined range and is in the boosting position 41 when the pressure drop is outside of the predetermined range.

When the LSBV 30 is in the load sense position 43, fluid flow through the bypass line BP is prevented and a non-boosted load sense signal is transmitted to the variable pump 14 through the load sense line LS via a load sense flow of fluid from the load sense junction 39 with a load sense pressure correlating to a downstream pressure (P_{L}) of fluid downstream of the orifice 32 at the load sense junction 39 of the supply line P. When the LSBV 30 is in the boosting position 41, fluid flow through the bypass line BP is permitted and a boosted load sense signal is transmitted to the variable pump 14 with a boosted pressure (P_{B}) greater than a load pressure (P_{L}) via a bypass flow of fluid from the first bypass junction 37 upstream of the orifice 32 through the LSBV 30 to the second bypass junction 38 and through the load sense line LS. In embodiments, the boosted pressure (P_{B}) correlates to a pressure of fluid upstream of the orifice 32 at the first bypass junction 37 of the supply line P.

In use, as the load on the actuator 11 increases, the load-induced pressure (P_{L}) downstream of the orifice 32 increases. This decreases the pressure drop across the orifice 32, which means flow across the orifice 32 decreases and the actuator 11 slows down. The load sense signal sent through the load sense line LS to the load sense signal port 23 of the pump 14 can be used by the load sensing controller of the pump 14 to adjust the displacement of the pump 14 to maintain a substantially constant pressure drop across the orifice 32 and therefore provide a substantially constant flow to the actuator 11. The load sensing controller of the pump 14 can be configured to respond to an increase in pressure of the load sense signal by increasing pump displacement (flow). As the pump pressure increases, this also increases the boost pressure (P_{B}) upstream of the orifice 32 by a correlated amount and helps to keep the pressure drop across the orifice 32 substantially constant, which keeps flow substantially constant. In embodiments, the pressure drop across the orifice 32 can be maintained in a suitable range around the desired constant pressure for the intended application, and the desired constant pressure drop across the orifice 32 can be any suitable pressure, such as a pressure in a range between 10 and 30 Bar (145 to 435 PSI).

The variable pump 14 can be configured to produce flow only as demanded by the actuator 11, thereby helping to improve the energy efficiency of the system 10 (with fewer losses to heat) and to provide more precise control and operation of the actuator 11. When the pump 14 is in standby mode, there is no flow of hydraulic fluid at the outlet port 22. In standby mode, the pump 14 displacement is near zero, but runs at an equilibrium that displaces enough hydraulic fluid to overcome internal leakage and maintain the set margin pressure (standby pressure).

The load sensing controller can be configured to respond to the load sense signal to match the displacement of the pump 14 to the flow demand of the system 10. At equilibrium, the pump outlet pressure is equal to the load signal pressure plus the margin pressure. As the pressure in the load sense line LS rises, the load sensing controller controls the pump 14 to increase displacement until the margin is satisfied and equilibrium returns.

To address problems of poor performance due to low margin, the LSBV 30 is configured to dynamically boost the load sense signal transmitted through the load sense line LS to the load sense signal port 23 of the pump 14 according to the desired margin pressure, and the flow demand from the system 10. The LSBV 30 can be configured to provide more hydraulic fluid flow to the actuator 11 in times of high demand by moving toward the boosting position 41 to provide a boosted load sense signal from upstream of the orifice 32 in a proportional manner to the reduced pressure drop across the orifice 32. When flow demand is low and the pressure drop across the orifice 32 is within a desired range, the LSBV 30 can save energy by moving toward the load sense position 43 to dynamically reduce the boosted load sense signal value to approach the load pressure (P_{L}) downstream of the orifice 32 (or by shifting fully to the actual load sense position 43 so that the pressure of the load sense signal is substantially the same as the load pressure (P_{L}).

The LSBV 30 can be configured to set a minimum margin pressure, or threshold of operation for the load-sensing boost feature. When flow demands are low, margin pressure will be above the set threshold, the LSBV 30 is in the load sense position 43, and no boosting occurs (the pressure in the load sense line LS is correlated to the load pressure (P_{L}) downstream of the orifice 32. When flow demands are at their highest, pressure in the load sensing line LS can drop below the needed margin. This would normally signal the pump 14 that additional flow is not required, but under these conditions the pump 14 would not provide the full available flow to the system, slowing down operation of the actuator 11. As the pressure in the load sense line LS drops to the set threshold, or minimum margin pressure, the LSBV 30 can move toward the boosting position 41 to dynamically boost the pressure of the load sense signal. When the LSBV 30 has moved toward the boosting position 41, hydraulic fluid flows through the bypass line BP into the load sense line and the pressure of the load sense signal is greater than the load pressure (P_{L}) downstream of the orifice 32, to thereby signal the pump 14 to stroke and displace more fluid.

In embodiments, the LSBV 30 can comprise a three-ported dynamic boosting valve with an adjustable threshold. In embodiments, the LSBV 30 includes an adjustable spring configured to provide a variable spring force N to urge the valve to the boosting position 41. In the illustrated embodiment, the LSBV 30 includes a pump port₁, a load sense signal port₂, and a load port₃. The pump port₁ is in fluid communication with the first bypass junction 37 such that the pump port₁ has a pressure equal to the boost pressure (P_{B}). The load sense signal port₂ is in fluid communication with the second bypass junction 38 such that the load sense signal port₂ has a pressure equal to the pressure in the load sense line. The load port₃ is in fluid communication with the load sense junction 39 such that the load port₃ has a pressure equal to the load pressure (P_{L}) downstream of the orifice 32. Hydraulic fluid at the pump port₁ and the load sense signal port₂ acts as pilot flow to urge the LSBV 30 to the load sense position 43, and hydraulic fluid at the load port₃ acts as pilot flow together with the adjustable spring force N of the LSBV 30 act in concert to urge the LSBV 30 to the boosting position 41. In embodiments, the area upon which the pressure at the load port₃ acts is equal to the sum of the areas upon which the pressure at the pump port₁ and the load sense signal port₂ acts.

Under normal flow and operating conditions, the pressure drop across the orifice 32 remains within the established margin and the LSBV 30 is in the load sense position 43 in which the load sense signal is generated by the load pressure (P_{L}) downstream of the orifice 32. When the difference between the pressure at the pump port₁ versus the pressure at load port₃ is reduced below a threshold, the LSBV 30 will move toward the boosting position 41 by the difference in forces between (i) ports 1 and 2 and (ii) port 3 plus the internal spring N setting of the LSBV 30. In embodiments, the LSBV 30 can comprise a completely mechanical valve that does not require sensors, electronics, controllers, or programming.

In embodiments, a hydraulic actuator system constructed according to principles of the present disclosure can provide a dynamic load sense signal boosting feature that allows the system 10 to recover high pressure drops that would normally degrade the margin pressure available for accurate pump control. Dynamically boosting the load sense signal can help save fuel because the load sense assembly 15 operates to boost the load sense signal only when a boost is needed.

In embodiments, a hydraulic actuator system constructed according to principles of the present disclosure can provide proper control pressure across the control valve (orifice) using lower energy consumption when compared with traditional static boosting arrangements. Traditional load sense boosters boost the load sense signal continuously and are not able to operate dynamically depending upon actual flow demands of the system 10. During times of low flow demand, the additional boost would waste fuel and causes the pump to work harder than is actually necessary.

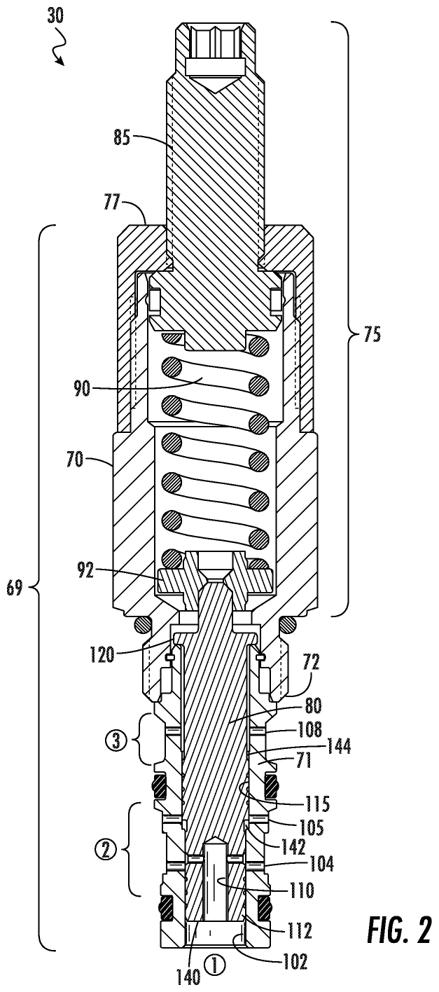

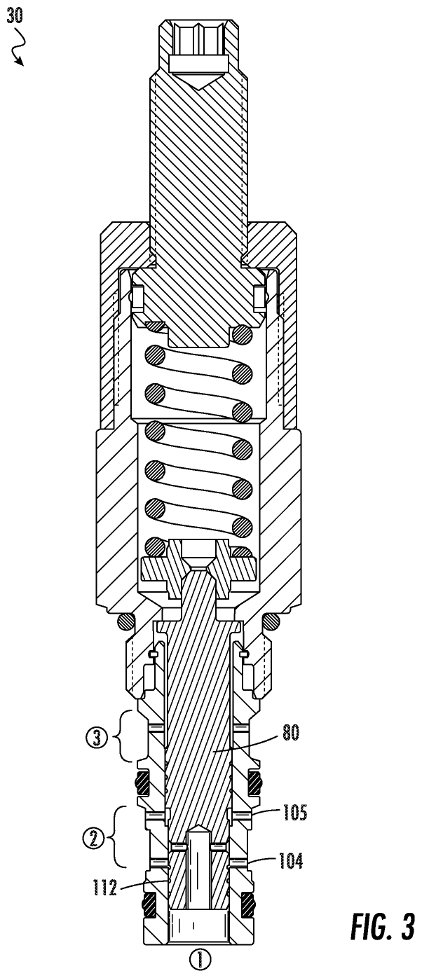

Referring to FIGS. 2 and 3, an embodiment of a load sense boost valve (LSBV) 30 constructed in accordance with principles of the present disclosure is depicted therein. The LSBV 30 is in the boosting position 41 in FIG. 2, and is in the load sense position 43 in FIG. 3.

Referring to FIG. 2, the LSBV 30 includes a body 69 with an adjuster housing in the form of an adaptor 70 and a cage 71 mounted to a first end 72 of the adaptor 70; a biasing assembly 75 disposed within the adaptor 70 such that a portion thereof extends from a second end 77 of the adaptor 70; and a spool 80 disposed within the cage 71 such that the spool 80 is reciprocally movable with respect to the cage 71. The biasing assembly 75 includes an adjuster 85, a spring 90, and a spring guide 92. The adjuster 85 is disposed such that a portion thereof extends from the second end 77 of the adaptor 70. The spring 90 is interposed between the adjuster 85 and the spring guide 92. The spring guide 92 is engaged with the spring 90 and the spool 80.

The adjuster housing in the form of the adaptor 70 is mounted to the cage 71. The biasing assembly 75 is disposed within the adjuster housing 70. The adaptor 70 and the cage 71 are generally cylindrical. The cage 71 is coupled to the first end 72 end of the adaptor 70, and the adjuster 85 is threadingly coupled to the other end 77 of the adaptor 70.

In embodiments, the body 69 of the LSBV defines an axial bore 102 and a pump port₁, a load sense signal port₂, and a load port₃. Each of the pump port₁, the load sense signal port₂, and the load port₃ is in fluid communication with the axial bore 102. In the illustrated embodiment, the cage 71 of the LSBV 30 defines the pump port₁, the load sense signal port₂, and the load port₃. The cage 71 is hollow and is configured to be inserted into a cavity formed in a suitable housing to facilitate the connection of the LSBV in the system 10.

The cage 71 defines the axial bore 102 that comprises the pump port₁ and a plurality of cross-holes arranged in rows that comprise the load sense signal port₂ and the load port₃. A first row 104 of metering cross holes and a second row 105 of feedback cross-holes define the load sense signal port₂. A third row 108 of feedback cross-holes define the load port₃.

The spool 80 is movably disposed within the cage 71 such that it is movable over a range of travel between the boosting position 41 in FIG. 2 and the load sense position 43 in FIG. 3. In embodiments, the spool 80 is configured such that the pump port₁ and the load sense signal port₂ are in fluid communication with each other when the spool 80 is in the boosting position, and the pump port₁ and the load sense signal port₂ are in fluid isolation from each other when the spool 80 is in the load sense position. The load port₃ is in fluid isolation from both the pump port₁ and the load sense signal port₂ over the range of travel of the spool 80.

In embodiments, the spool 80 defines a through passage 110 that is configured such that the pump port₁ and the load sense signal port are in fluid communication with each other via the through passage 110 when the spool 80 is in the boosting position. Referring to FIG. 2, the spool 80 defines a fluid through passage 110 that permits fluid flow therethrough such that the pump port₁ and the load sense signal port₂ are in fluid communication with each other via the first row 104 of metering cross holes when the spool 80 is in the boosting position 41 in FIG. 2.

The spool 80 includes a first portion 112 that is sealingly engaged with the interior of the cage 71 such that, when the spool 80 is in the load sense position 43 in FIG. 3, the first portion 112 sealingly occludes the first row 104 of metering cross holes to prevent fluid flow between the pump port₁ and the load sense signal port₂. When the spool 80 is in the load sense position 43 in FIG. 3, the pressure at the load sense signal port₂ can still act upon the spool 80 via the second row 105 of feedback cross-holes. The pressure at the pump port₁ and the load sense signal port₂ acts to urge the spool 80 toward the load sense position 43 in FIG. 3.

Referring back to FIG. 2, the spool 80 includes a second portion 115 that is intermediately disposed. The second portion 115 is sealingly engaged with the interior of the cage 71 such that the load port₃ is fluidly isolated from both the pump port₁ and the load sense signal port₂ over the range of travel of the spool 80. The movement of the spool 80 relative to the cage 71 is limited by the interference of a flange 120 projecting from the spool 80 with the cage 71 and the adaptor 70. The pressure at the load port₃ acts to urge the spool 80 toward the boosting position 41 in FIG. 2.

The spool 80 includes a first pressure surface 140 in fluid communication with the pump porti, a second pressure surface 142 in fluid communication with the load sense signal port₂, and a third pressure surface 144 in fluid communication with the load port₃. The third pressure surface 144 faces in opposing relationship to the first and second pressure surfaces 140, 142 such that pressure acting against the third pressure surface 144 urges the spool 80 to move to the boosting position 41 in FIG. 2, and pressure acting against the first and second pressure surfaces 140, 142 urges the spool 80 to move to the load sense position 43 in FIG. 3. The second portion 115 of the spool 80 is intermediately disposed between the second pressure surface 142 and the third pressure surface 144.

The pump port₁ is in fluid communication with the first pressure surface 140 of the spool 80 over the range of travel of the spool 80. The second row 105 of feedback cross-holes are in fluid communication with the second pressure surface 142 of the spool 80 over the range of travel of the spool 80. The third row 108 of feedback cross-holes are in fluid communication with the third pressure surface 144 of the spool 80 over the range of travel of the spool 80.

In embodiments, the area upon which the pressure at the load port₃ acts is equal to the sum of the areas upon which the pressure at the pump port₁ and the load sense signal port₂ acts. In embodiments, the area upon which the pressure at the pump port₁ acts is greater than the area upon which the pressure at the load sense signal port₂ acts.

In embodiments, the first, second, and third pressure surfaces 141, 142, 144 have a first area, a second area, and a third area, respectively. In embodiments, the third area is substantially equal to the sum of the first and second areas. In embodiments, the first area is greater than the second area.

The biasing assembly 75 is configured to urge the spool 80 to the boosting position 41 in FIG. 2 via an adjustable biasing force. The biasing assembly 75 includes the adjuster 85 and the spring 90 to provide the adjustable biasing force. The adjuster 85 is movably mounted to the adjuster housing 70 and configured such that moving the adjuster 85 varies the adjustable biasing force provided by the spring.

The spring 90 urges the spool 80 toward the boosting position 41 in FIG. 2 such that the spool 80 is biased to engage a stop defined by the cage 80. The spring force can be adjusted with the adjuster 85 by moving the adjuster axially with respect to the adaptor 70. In embodiments, the adjuster 85 can have any suitable form and can be retained in place using any suitable technique as will be appreciated by one skilled in the art. For example, in embodiments, the adjuster 85 can be locked in a range of positions with a lock nut which is threadedly engaged to the adjuster 85.

When the forces exerted by the pressure at the load port₃ and the spring 90 exceed the forces exerted by the pressure at the pump port₁ and the load sense signal port₂, the LSBV 30 moves toward the boosting position 41 shown in FIG. 2. When the forces exerted by the pressure at the pump port₁ and the load sense signal port₂ exceed the forces exerted by pressure at the load port₃ and the spring 90, the LSBV 30 moves toward the load sense position 43 shown in FIG. 3.

Embodiments of a hydraulic actuator system constructed according to principles of the present disclosure can be used to carry out a method of controlling a hydraulic actuator using a load sense assembly that is configured to direct a dynamically boosted load sense signal to a variable pump under certain flow conditions. In embodiments, a method of controlling a hydraulic actuator following principles of the present disclosure can be used with any embodiment of a hydraulic actuator system according to principles discussed herein.

In one embodiment, a method of controlling a hydraulic actuator includes transmitting a load sense signal to a variable pump. A flow of fluid is discharged from the variable pump through a supply line to an actuator. The flow of fluid is based upon a pressure of the load sense signal. The pressure of the load sense signal transmitted to the variable pump is dynamically increased to maintain a pressure drop across an orifice within a predetermined range, the orifice disposed within the supply line between the variable pump and the actuator. In embodiments, dynamically increasing the pressure of the load sense signal comprises increasing the pressure to a value greater than an actual load pressure of the actuator.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hydraulic actuator system comprising:
a variable pump, the variable pump configured to selectively deliver a flow of fluid, the variable pump configured to vary the flow of fluid based upon a pressure of a load sense signal received;
an actuator, the actuator in fluid communication with the variable pump to receive the flow of fluid therefrom;
a supply line, the supply line in fluid communication with the variable pump and the actuator to deliver the flow of fluid from the variable pump to the actuator;
a load sense assembly, the load sense assembly in fluid communication with the variable pump via the supply line, the load sense assembly configured to transmit the load sense signal to the variable pump, the load sense assembly configured to increase the pressure of the load sense signal to increase the flow of fluid from the variable pump while the flow of fluid in the supply line meets a hydraulic condition.

2. The hydraulic actuator system according to claim 1, wherein the supply line includes a first bypass junction and a load sense junction, the first bypass junction being closer to the variable pump than the load sense junction, the load sense assembly further comprising:
a load sense line, the load sense line in fluid communication with the variable pump and the supply line via the load sense junction, the load sense line including a second bypass junction,
a bypass line, the bypass line in fluid communication with the first bypass junction and with the second bypass junction,
an orifice, the orifice being disposed within the supply line such that the orifice is interposed between the first bypass junction and the load sense junction, and
a load sense boost valve (“LSBV”), the load sense boost valve disposed within the bypass line, the LSBV being movable over a range of travel between a boosting position and a load sense position, wherein:
the bypass line is open when the LSBV is in the boosting position to permit fluid flow from the first bypass junction through the LSBV to the second bypass junction,
the bypass line is occluded when the LSBV is in the load sense position, and
the LSBV is in the boosting position when the hydraulic condition exists.

3. The hydraulic actuator system according to claim 2, further comprising:
a tank, the tank adapted to hold a reservoir of fluid, the tank in fluid communication with the variable pump, the actuator, and the load sense assembly in an open hydraulic circuit arrangement;
wherein the variable pump includes an inlet port, an outlet port, and a load sense signal port, the inlet port of the variable pump being in fluid communication with the tank, the outlet port of the variable pump being in fluid communication with the actuator and the load sense assembly via the supply line, and the load sense signal port of the variable pump being in fluid communication with the load sense assembly, the variable pump being configured to draw the supply of fluid from the tank through the inlet port and to discharge the flow of hydraulic fluid from the outlet port to the actuator via the supply line, and the variable pump configured to receive the load sense signal from the load sense line via the load sense signal port.

4. The hydraulic actuator system according to claim 3, wherein the variable pump includes a load sensing controller configured to vary the flow of fluid discharged from the outlet port of the variable pump based upon the pressure of the load sense signal received by the load sense signal port of the variable pump via the load sense line, and wherein the LSBV is in fluid communication with the outlet port of the variable pump via the supply line and the bypass line, the LSBV is in fluid communication with the load sense signal port of the pump via the load sense line, the orifice is in fluid communication with the outlet port of the pump via the supply line such that the orifice is interposed between the variable pump and the actuator.

5. The hydraulic actuator system according to claim 2, wherein the hydraulic condition comprises a pressure drop across the orifice being outside of a predetermined range such that the LSBV is in the load sense position when the pressure drop across the orifice is within the predetermined range and is in the boosting position when the pressure drop is outside of the predetermined range, wherein:
when the LSBV is in the load sense position, fluid flow through the bypass line is prevented and a non-boosted load sense signal is transmitted to the variable pump through the load sense line via a load sense flow of fluid from the load sense junction with a load sense pressure correlating to a downstream pressure of fluid downstream of the orifice at the load sense junction of the supply line, and
when the LSBV is in the boosting position, fluid flow through the bypass line is permitted and a boosted load sense signal is transmitted to the variable pump with a boosted pressure greater than a load pressure via a bypass flow of fluid from the first bypass junction upstream of the orifice through the LSBV to the second bypass junction and through the load sense line, the boosted pressure correlating to an upstream pressure of fluid upstream of the orifice at the first bypass junction of the supply line.

6. The hydraulic actuator system according to claim 5, wherein the load sense assembly includes a one-way flow device configured to prevent fluid flow from the bypass line from flowing in the load sense line from the second bypass junction to the load sense junction.

7. The hydraulic actuator system according to claim 5, wherein the load sense assembly includes a check valve, the check valve being disposed within the load sense line between the load sense junction and the second bypass junction such that fluid flow is permitted from the load sense junction toward the second bypass junction and is prevented from the second bypass junction to the load sense junction.

8. The hydraulic actuator system according to claim 5, wherein the LSBV includes an adjustable spring configured to provide a variable spring force to urge the valve to the boosting position, and wherein the LSBV includes a pump port, a load sense signal port, and a load port, the pump port being in fluid communication with the first bypass junction such that the pump port has a pressure equal to the boost pressure, the load sense signal port being in fluid communication with the second bypass junction such that the load sense signal port has a pressure equal to the pressure in the load sense line, and the load port being in fluid communication with the load sense junction such that the load port has a pressure equal to the load pressure downstream of the orifice in the supply line, and wherein the LSBV is configured such that fluid at the pump port and at the load sense signal port acts as pilot flow to urge the LSBV to the load sense position, and fluid at the load port acts as pilot flow together with the variable spring force of the adjustable spring act to urge the LSBV to the boosting position.

9. The hydraulic actuator system according to claim 8, wherein the LSBV is configured such that a first area upon which pressure at the load port acts is equal to a sum of a second area and a third area upon which pressure at the pump port and the load sense signal port respectively acts.

10. A load sense boost valve comprising:
a body, the body defining an axial bore, a pump port, a load sense signal port, and a load port, each of the pump port, the load sense signal port, and the load port being in fluid communication with the axial bore;
a spool, the spool being movably disposed within the axial bore over a range of travel between a boosting position and a load sense position, the pump port and the load sense signal port being in fluid communication with each other when the spool is in the boosting position, and the pump port and the load sense signal port being in fluid isolation from each other when the spool is in the load sense position, and the load port being in fluid isolation from both the pump port and the load sense signal port over the range of travel of the spool, wherein
the spool defines a through passage configured such that the pump port and the load sense signal port are in fluid communication with each other via the through passage when the spool is in the boosting position, and
the spool includes a first pressure surface in fluid communication with the pump port, a second pressure surface in fluid communication with the load sense signal port, and a third pressure surface in fluid communication with the load port, the third pressure surface facing in opposing relationship to the first and second pressure surfaces such that pressure acting against the third pressure surface urges the spool to move to the boosting position and pressure acting against the first and second pressure surfaces urges the spool to move to the load sense position; a biasing assembly, the biasing assembly disposed within the body and configured to urge the spool to the boosting position via an adjustable biasing force.

11. The load sense boost valve according to claim 10, wherein the body includes a cage and an adjuster housing, the cage defining the pump port, the load sense signal port, and the load port, the adjuster housing mounted to the cage, and the biasing assembly disposed within the adjuster housing.

12. The load sense boost valve according to claim 11, the cage defines the axial bore of the body, the axial bore comprising the pump port, a first row of metering cross holes and a second row of feedback cross-holes comprising the load sense signal port, and a third row of feedback cross-holes comprising the load port, wherein
the pump port and the load sense signal port are in fluid communication with each other via the through passage of the spool and the first row of metering cross holes of the cage when the spool is in the boosting position, and
the second row of feedback cross-holes are in fluid communication with the second pressure surface of the spool over the range of travel of the spool, and
the third row of feedback cross-holes are in fluid communication with the third pressure surface of the spool over the range of travel of the spool.

13. The load sense boost valve according to claim 12, wherein the spool includes a first portion that is sealingly engaged with the cage such that, when the spool is in the load sense position, the first portion sealingly occludes the first row of metering cross holes to prevent fluid flow between the pump port and the load sense signal port, and, pressure at the load sense signal port can act upon the second pressure surface of the spool via the second row of feedback cross-holes.

14. The load sense boost valve according to claim 13, wherein the spool includes a second portion that is intermediately disposed between the second pressure surface and the third pressure surface, the second portion being sealingly engaged with the cage such that the load port is fluidly isolated from both the pump port and the load sense signal port over the range of travel of the spool.

15. The load sense boost valve according to claim 14, wherein the spool includes a flange configured to interferingly engage the cage and the adjuster housing to limit the range of travel of the spool.

16. The load sense boost valve according to claim 14, wherein the biasing assembly includes an adjuster and a spring to provide the adjustable biasing force, the adjuster movably mounted to the adjuster housing and configured such that moving the adjuster varies the adjustable biasing force.

17. The load sense boost valve according to claim 14, wherein the first, second, and third pressure surfaces have a first area, a second area, and a third area, respectively, and wherein the third area is substantially equal to the sum of the first and second areas.

18. The load sense boost valve according to claim 17, wherein the first area is greater than the second area.

19. A method of controlling a hydraulic actuator, the method comprising:
transmitting a load sense signal to a variable pump;
discharging a flow of fluid from the variable pump through a supply line to an actuator, the flow of fluid based upon a pressure of the load sense signal;
dynamically increasing the pressure of the load sense signal transmitted to the variable pump to maintain a pressure drop across an orifice within a predetermined range, the orifice disposed within the supply line between the variable pump and the actuator.

20. The method according to claim 19, wherein dynamically increasing the pressure of the load sense signal comprises increasing the pressure to a value greater than an actual load pressure of the actuator.
